(19) United States
(12) Patent Application Publication
(10) Pub. No.: US 2016/0117202 A1
(43) Pub. Date: Apr. 28, 2016

(54) PRIORITIZING SOFTWARE APPLICATIONS TO MANAGE ALERTS

(71) Applicant: Kamal Zamer, Austin, TX (US)

(72) Inventor: Kamal Zamer, Austin, TX (US)

(21) Appl. No.: 14/525,788

(22) Filed: Oct. 28, 2014

(51) Int. Cl. G06F 9/54; G06N 99/00

(52) U.S. Cl. CPC G06F 9/54; G06N 99/005

(57) ABSTRACT

In an example embodiment, a priority status for one or more of the plurality of software applications is determined. A mapping is then created between the one or more of the plurality of software applications and each corresponding priority status. Then, based on the mapping, one or more alerts received from the plurality of software applications are suppressed.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to prioritizing software applications to manage alerts.

### BACKGROUND

As computer devices (and their corresponding users) become more and more connected to one another, there has been an increase in the number of alerts presented to users of the computer devices. It is not uncommon for users to be bombarded with alerts every few minutes from, for example, incoming email messages, text messages, phone calls, social networking update alerts, news alerts, calendar reminders, task alerts, etc. This can have a significant effect on user productivity. For example, a user may be conducting a presentation for a group of people using a projector coupled to his or her laptop computer, and the presentation itself may be interrupted by various incoming email alerts and news alerts that have nothing to do with the presentation. While it is possible for users to set generic “do not disturb” settings for particular times, this requires that the user actively decide that a particular time necessitates the do not disturb setting and then actively set the setting, not to mention remember to remove the do not disturb setting when the activity is complete, lest the user miss important alerts later in the day.

### BRIEF DESCRIPTION OF THE DRAWINGS

Some embodiments are illustrated by way of example and not limitation in the figures of the accompanying drawings in which:

FIG. 1 is a block diagram illustrating a system, in accordance with an example embodiment, for managing alerts in a computer system.

FIG. 2 is a block diagram illustrating a system, in accordance with another example embodiment, for managing alerts in a computer system.

FIG. 3 is a block diagram illustrating a system, in accordance with another example embodiment, for managing alerts in a computer system.

FIG. 4 is a block diagram illustrating an application priority component in accordance with one or more of these embodiments.

FIG. 5 is a block diagram illustrating an alert type management component in accordance with an example embodiment.

FIG. 6 is a flow diagram illustrating a method, in accordance with an example embodiment, of managing alerts from software applications.

FIG. 7 is a flow diagram illustrating a method, in accordance with another example embodiment, of managing alerts from software applications.

FIG. 8 is a block diagram illustrating a mobile device, according to an example embodiment.

FIG. 9 is a block diagram of a machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

In an example embodiment, alerts in a computer system are managed in a way that prevents alerts that are not necessary under the current conditions. In one example embodiment, one or more software applications may be assigned a priority such that if a “priority” application is being run, all alerts from other software applications are automatically blocked. In an example embodiment, this priority status is established by a developer of an operating system running the computer system. In another example embodiment, this priority status is established by a user of the computer system. In another example embodiment, this priority status is determined automatically and dynamically based on an environment of the computer system, using information such as, for example, the location of the computer system, the time of day, and calendar information. Thus, in the latter example embodiment, the operating system may detect an appropriate priority status for a running application (as well as potentially interrupting applications) at runtime based on the current circumstances.

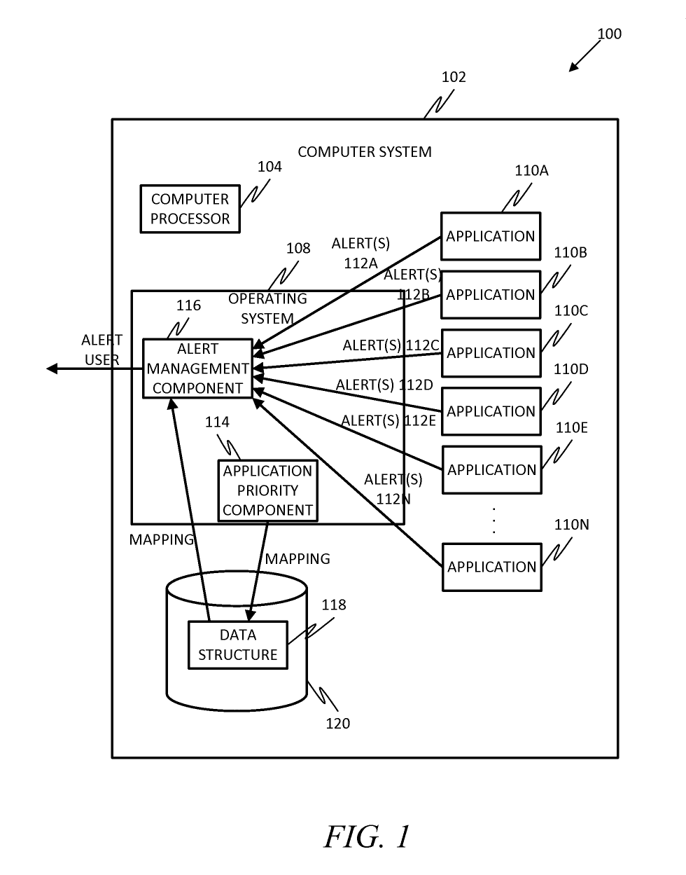

FIG. 1 is a block diagram illustrating a system 100, in accordance with an example embodiment, for managing alerts in a computer system. The system 100 may include computer system 102 which may be one of any of many different types of computer systems. While detailed examples of computer systems will be described in more detail later, generally the computer system 102 may be a desktop, laptop, tablet, smartphone, smartwatch, or other wearable device that is or includes a computer (e.g., a device having a computer processor 104). There are, of course, many different types of component other than a computer processor 104 that may be included in the computer system 102, but for simplicity, most of these other types of components are not pictured here.

The computer system 102 may also contain an operating system 108 which generally acts to manage the computer processor 104 as well as a plurality of applications 110A-110N. Each of the applications 110A-110N may be independently run by the operating system 108 at various times during the functioning of the computer system 102, although it may also be quite common for multiple applications 110A-110N to be run simultaneously (or nearly simultaneously) through a process commonly known as “multitasking”).

Each of the multiple applications 110A-110N may, at various times, generate one or more alerts 112A-112N. While each application 110A-110N is depicted here as generating at least one alert 112A-112N, there may be some applications 110A-110N that, for a variety of reasons such as not being run, having alert functions turned off, or not encountered conditions warranting an alert, may not actually generate an alert. These alerts 112A-112N can be any of multiple different notifications that are deemed important by the corresponding application 110A-110N. For example, if the computer system 102 is a smartphone and the application 110A is a phone program, the alert 112A may be an indication of an incoming call. Likewise, if application 110B is a calendar application, the alert 112B may be an indication of an upcoming or overdue calendar event, such as a meeting.

In an example embodiment, the operating system 108 contains an application priority component 114 and an alert management component 116. The application priority component 114 may act to determine a priority for one or more of the applications 110A-110N. It is not necessary that the application priority component 114 determine a priority for all of the applications 110A-110N or even a plurality of the applications 110A-110N. In one example embodiment, the application priority component 114 may only assign a priority status to a single application 110A-110N and all other of the applications 110A-110N will be deemed as having secondary status to the application 110A-110N having been assigned priority status. In other example embodiments, some, but not all of the applications 110A-110N will be assigned priority statuses. There may, for example, be different degrees, levels, or scores of priority status. For example, a highest priority status application 110A-110N may be assigned a “10” while a lowest priority status application 110A-110N may be assigned a “1”, with all applications 110A-110N being assigned some priority status between “1” and “10”.

The application priority component 114 will be described in more detail below, but generally, as described earlier, the application priority component 114 my determine the priority for one or more of the applications 110A-110N by referring to a data structure 118 stored in a data store 120, such as on a hard drive of the computer system 102. The data structure 118 may contain a mapping between one or more of the applications 110A-110N and priority statuses corresponding to those one or more applications 110A-110N. The mapping may be created by an operating system designer, a user, or any other person, or any combination thereof. For example, it is possible that the operating system designer may set a default mapping which can be altered by the user and/or by an application developer of an application installed on the computer system 102.

In an alternative embodiment, again as will be described in more detail below, the application priority component 114 can dynamically determine application priority statuses at runtime based on various environmental and/or other information, thus the mapping may be created dynamically and may or may not be stored in the data structure 118 in the data store 120.

The alert management component 116 may utilize the mapping to determine whether particular alerts 112A-112N should be blocked and/or otherwise handled in a special manner when received from the one or more applications 110A-110B.

It should be noted that while FIG. 1 depicts a single computer system 102, multiple computer systems may be designed to work together to generate alerts. For example, a user may configure a smartphone to notify the user's laptop computer when an incoming call is received, and the user's laptop computer (and more precisely an application or operating system 108 on the user's laptop computer) may receive this notification and generate an alert. Indeed, alerts may be nested in this or other ways.

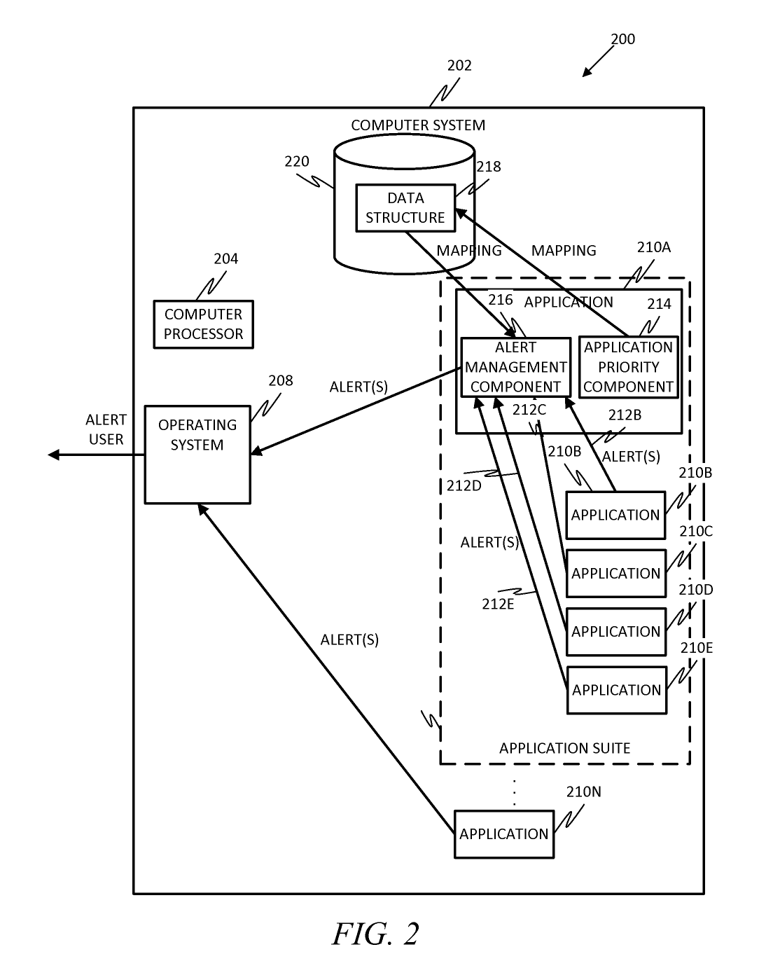

FIG. 2 is a block diagram illustrating a system 200, in accordance with another example embodiment, for managing alerts in a computer system. The system 200 may include computer system 202 which may be one of many different types of computer systems. While detailed examples of computer systems will be described in more detail later, generally the computer system 202 may be a desktop, laptop, tablet, smartphone, smartwatch, or other wearable device that is or includes a computer (e.g., a device having a computer processor 204). There are, of course, many different types of component other than a computer processor 204 that may be included in the computer system 202, but for simplicity, most of these other types of components are not pictured here.

The computer system 202 may also contain an operating system 208 which generally acts to manage the computer processor 204 as well as a plurality of applications 210A-210N. Each of the applications 210A-210N may be independently run by the operating system 208 at various times during the functioning of the computer system 202, although it may also be quite common for multiple applications 210A-210N to be run simultaneously (or nearly simultaneously) through a process commonly known as “multitasking”). In one example embodiment pictured here, a plurality of the applications 210A-210N, specifically applications 210A-210E may be a “suite” of applications, meaning the applications are created or distributed by the same entity and may have cross-functionality with each other.

Each of the multiple applications 210A-210E in the suite of applications may, at various times, generate one or more alerts 212B-212E. While each application 210A-210E is depicted here as generating at least one alert 212B-212E there may be some applications 210A-210E that, for a variety of reasons such as not being run, having alert functions turned off, or not encountering conditions warranting an alert, may not actually generate an alert. These alerts 212B-212E can be any of multiple different notifications that are deemed important by the corresponding application 210A-210E. For example, if the computer system 202 is a smartphone and the application 210B is an ecommerce application that can serve auction sales, the alert 212B may be an indication of an impending auction closing. Likewise, if application 210C is an event ticket sales application, the alert 212C may be an indication that an event of interest has had a change in its starting time.

In an example embodiment, one of the applications 210A-210E in the suite, here application 210A, may contain an application priority component 214 and an alert management component 216. The application priority component 214 may act to determine a priority for one or more of the applications 210A-210E in the suite. It is not necessary that the application priority component 214 determine a priority for all of the applications 210A-210E or even a plurality of the applications 210A-210E in the suite. In one example embodiment, the application priority component 214 may only assign a priority status to a single application 210A-210E in the suite and all other of the applications 210A-210E will be deemed as having secondary status to the application 210A-210E having been assigned priority status. In other example embodiments, some, but not all of the applications 210A-210E will be assigned priority statuses. There may, for example, be different degrees, levels, or scores of priority status. For example, a highest priority status application 210A-210E may be assigned a “10” while a lowest priority status application 210A-210E may be assigned a “1”, with all applications 210A-210E being assigned some priority status between “1” and “10”.

The application priority component 214 will be described in more detail below, but generally, as described earlier, the application priority component 214 may determine the priority for one or more of the applications 210A-210N by referring to a data structure 218 stored in a data store 220, such as on a hard drive of the computer system 202. The data structure 218 may contain a mapping between one or more of the applications 210A-210E in the suite and priority statuses corresponding to those one or more applications 210A-210E. The mapping may be created by an application designer, a user, or any other person, or any combination thereof. For example, it is possible that the application designer may set a default mapping which can be altered by the user.

In an alternative embodiment, again as will be described in more detail below, the application priority component 214 can dynamically determine application priority statuses at runtime based on various environmental and/or other information, and thus the mapping may be created dynamically and may or may not be stored in the data structure 218 in the data store 220.

The alert management component 216 may utilize the mapping to determine whether particular alerts 212A-212E should be blocked and/or otherwise handled in a special manner when received from the one or more applications 210A-210E. This alert management component 216 may then pass relevant alerts to the operating system, which may act to actually distribute the alert to the user or otherwise notify the user.

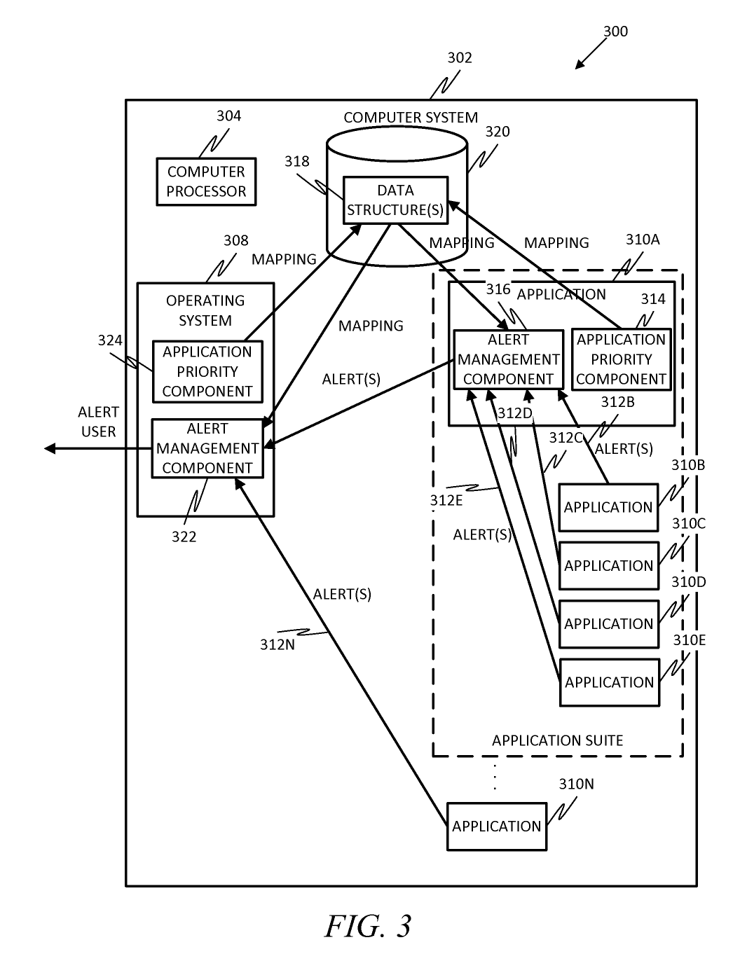

FIG. 3 is a block diagram illustrating a system 300, in accordance with another example embodiment, for managing alerts in a computer system. The system 300 may include computer system 302 which may be one of many different types of computer systems. While detailed examples of computer systems will be described in more detail later, generally the computer system 302 may be a desktop, laptop, tablet, smartphone, smartwatch, or other wearable device that is or includes a computer (e.g., a device having a computer processor 304). There are, of course, many different types of component other than a computer processor 304 that may be included in the computer system 302, but for simplicity, most of these other types of components are not pictured here.

The computer system 302 may also contain an operating system 308 which generally acts to manage the computer processor 304 as well as a plurality of applications 310A-310N. Each of the applications 310A-210N may be independently run by the operating system 308 at various times during the functioning of the computer system 302, although it may also be quite common for multiple applications 310A-310N to be run simultaneously (or nearly simultaneously) through a process commonly known as “multitasking”). In one example embodiment pictured here, a plurality of the applications 310A-310N, specifically applications 310A-310E may be a “suite” of applications, meaning the applications are created or distributed by the same entity and may have cross-functionality with each other.

Each of the multiple applications 310A-310N may, at various times, generate one or more alerts 312B-312N. While each application 310A-310N is depicted here as generating at least one alert 312B-312N there may be some applications 310A-310N that, for a variety of reasons such as not being run, having alert functions turned off, or not encountering conditions warranting an alert, may not actually generate an alert. These alerts 312B-312N can be any of multiple different notifications that are deemed important by the corresponding application 310A-310N. For example, if the computer system 302 is a smartphone and the application 310B is an ecommerce application that can serve auction sales, the alert 312B may be an indication of an impending auction closing. Likewise, if application 310C is an event ticket sales application, the alert 312C may be an indication that an event of interest has had a change in its starting time. Likewise, if the application 310N is a phone program, the alert 312N may be a notification of an incoming call.

In an example embodiment, one of the applications 310A-310E in the suite, here application 310A, may contain an application priority component 314 and an alert management component 316. The application priority component 314 may act to determine a priority for one or more of the applications 310A-310 in the suite. It is not necessary that the application priority component 314 determine a priority for all of the applications 310A-310E or even a plurality of the applications 310A-310E in the suite. In one example embodiment, the application priority component 314 may only assign a priority status to a single application 310A-310E in the suite and all other of the applications 310A-310E in the suite will be deemed as having secondary status to the application 310A-310E having been assigned priority status. In other example embodiments, some, but not all of the applications 310A-310E will be assigned priority statuses. There may, for example, be different degrees, levels, or scores of priority status. For example, a highest priority status application 310A-310E may be assigned a “10” while a lowest priority status application 310A-310E may be assigned a “1”, with all applications 310A-310E in the suite being assigned some priority status between “1” and “10”.

The application priority component 314 will be described in more detail below, but generally, as described earlier, the application priority component 314 may determine the priority for one or more of the applications 310A-310N by referring to a data structure 318 stored in a data store 320, such as on a hard drive of the computer system 302. The data structure 318 may contain a mapping between one or more of the applications 310A-310E in the suite and priority statuses corresponding to those one or more applications 310A-310E. The mapping may be created by an application designer, a user, or any other person, or any combination thereof. For example, it is possible that the application designer may set a default mapping which can be altered by the user.

In an alternative embodiment, again as will be described in more detail below, the application priority component 314 can dynamically determine application priority statuses at runtime based on various environmental and/or other information, and thus the mapping may be created dynamically and may or may not be stored in the data structure 318 in the data store 320.

The alert management component 316 may utilize the mapping to determine whether particular alerts 312B-312E should be blocked and/or otherwise handled in a special manner when received from the one or more applications 310A-310E. This alert management component 316 may then pass relevant alerts to an alert management component 322 of the operating system 308, which may act to actually distribute the alert to the user or otherwise notify the user.

In an example embodiment, the operating system 308 contains its own application priority component 324 in addition to its own alert management component 322. The application priority component 324 may act to determine a priority for the suite of application 310A-310E as a whole, as well as one or more of the other applications 310N. The application priority component 324 and alert management component 322 can operate in a similar manner to the application priority component 114 and alert management component 116 of FIG. 1. It should be noted that, in some embodiments, data structure 318 is actually more than one data structure, allowing for a different mapping from application priority component 314 to be stored than from application priority component 324.

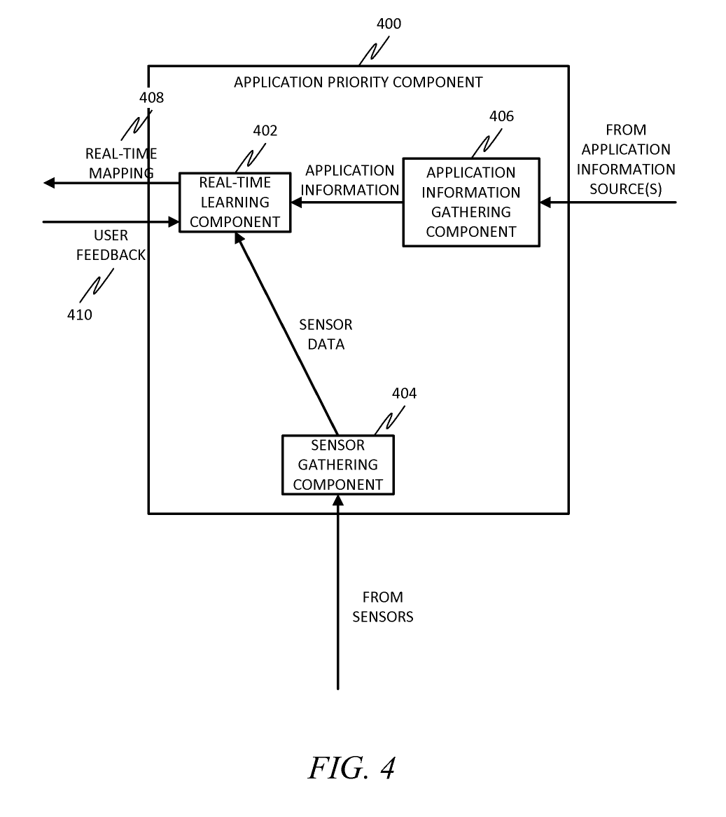

Turning now to the aforementioned embodiment(s) where the application priority component can dynamically determine application priority statuses at runtime based on various environmental and/or other information, FIG. 4 is a block diagram illustrating an application priority component 400 in accordance with one or more of these embodiments. In various example embodiments, application priority component 400 may be any or all of application priority component 114 of FIG. 1, application priority component 214 of FIG. 2, application priority component 314 of FIG. 3 and/or application priority component 324 of FIG. 3.

Application priority component 400 may contain a real-time learning component 402 which may employ various machine-learning algorithms to learn user and environmental patterns. A sensor gathering component 404 may gather sensor information from one or more sensors, either inside or outside of the computer system 302 in which the application priority component 400 resides. These sensors may include, for example, global positioning system (GPS) sensors relaying position information, clocks relaying time and/or date information, microphones relaying audio information, cameras relaying image information, accelerometers relaying acceleration information, gyroscopes relaying orientation information, and so on. Sensor information may be passed from the sensor gathering component 404 to the real-time learning component 402. An application information gathering component 406 may gather information on one or more of the applications to be assigned a priority. This information may include, for example, details of what the applications are, what functions they perform, typical circumstances in which they operate, types of alerts they generate, etc. The application information gathering component 406 may send this information to the real-time learning component 402. The real-time learning component 402 may then use this information, along with the sensor information, to determine a real-time mapping 408 between one or more applications and priority statuses. In an example embodiment, the real-time learning component 402 may also apply one or more machine-learning techniques to adapt the mapping in real time based on user feedback 410.

The following are example use cases for various aspects of the present disclosure. These use cases are merely examples and are not intended to be limiting. These use cases present specific aspects of the components described above, and specifically provide example algorithms used by the real-time learning component 402 in determining a priority status for which application and thus, ultimately, what applications can interrupt a currently running application and what applications cannot.

The above descriptions assume that all alerts from a given application are treated equally (according to the priority level of the given application). In an example embodiment, however, there may be different types of alerts or different content related to the alerts and the priority level may impact each of these different types of alerts or content differently. For example, if a phone application is given a high priority status, then alerts for any incoming phone call may cause a ringer on smartphone to ring. If the phone application is given a lower priority status, however, then alerts from certain users (such as family) may cause a ringer on the smartphone to ring while alerts from other users may not trigger a ring. Likewise, the system may block all voice mail notifications from the phone application (no matter who has left the voice mail messages), while still delivering some incoming call alerts as described above.

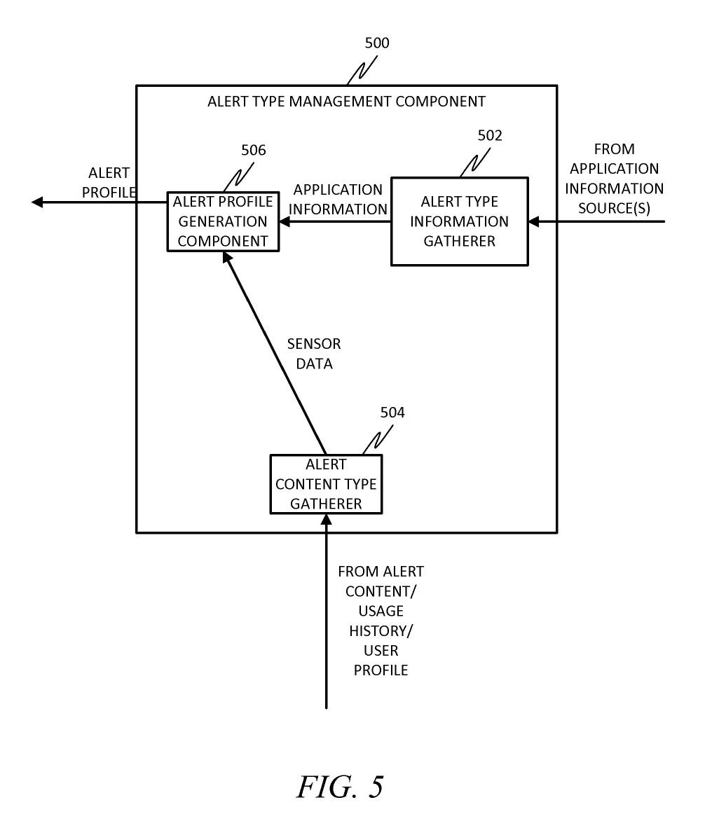

FIG. 5 is a block diagram illustrating an alert type management component 500 in accordance with an example embodiment. In some example embodiments the alert type management component 500 may be located in a real-time learning component such as the real-time learning component 402 of FIG. 4. The alert type management component 500 may include an alert type information gatherer 502. The alert type information gatherer 502 may act to gather information on different alert types from various applications from which alerts may be received. This information may include, for example, an identification of each alert type, an indication as to how a component can identify such an alert type when it is received (e.g., look for a particular field in the alert data structure, deduce the alert type based on the format of the alerts, etc.), and information about the absolute and/or relative importance of such an alert (e.g., incoming phone calls are typically more pressing than voice mail notifications).

The alert type management component 500 may also include an alert content type gatherer 504. The alert content type gatherer 504 may act to gather information about alert content types. In an example embodiment, this information can be gathered from one or more user profiles stored on a user device. For example, a user profile may contain contact information and thus the alert content type gatherer 504 can gain access to the contact list to identify the contacts as important (or identify a subset of the contacts as important). In another example embodiment, this alert content type information can be derived from learning algorithms applied to actual user usage. For example, the alert content type gatherer 504 may deduce that the user has received an average of 5 calls a day from a particular phone number and therefore deduce that the phone number is an important contact.

An alert profile generation component 506 may use the information from the alert type information gatherer 502 and alert content type gatherer 504 to create an alert profile, which may include, for example, a mapping between alert types and/or alert content types and relative or absolute importance levels. The alert profile may be stored in an alert profile data store and used by, for example, the real-time learning component 402 of FIG. 4 in prioritizing alerts as well as by an alert management component 316 to manage how alerts are suppressed or altered in response to incoming alerts from applications.

In a first example use case, a user is giving a presentation at work. This environmental information may be gathered in a number of different ways. In one example embodiment, this information is gleaned from the fact that the user has opened a particular slide presentation application and has hooked his computer system 302 to a projector. In another example embodiment, this information is gleaned from the fact that the user has a calendar entry indicating a presentation is to be presented at a certain time and at a certain place, and a current time from a clock indicates that the current time matches the time when the presentation is to take place and the location information from a GPS sensor indicates that the user is at work. Additional information can be utilized as well, such as the fact that the user has selected that the slide presentation application is operating in a full screen mode. A real-time learning component 402 may then utilize this information, along with information about the slide presentation application (such as the fact that it is often used for presentations during which interruptions can be disruptive) to derive a mapping where the slide presentation application is given top priority. As described above, other applications on the user's computing device 302 may be assigned various levels of priority lower than the slide presentation application. Depending upon various settings and/or assumptions, one or more alerts from these other applications may be blocked while the above conditions are in place. The real-time learning component 402 is also able to learn when the presentation is over, such as if the user disconnects the projector, or the time for the meeting lapses, and lower the priority status of the slide projector application so that one or more other applications can resume interrupting the slide projector application if necessary. Feedback from the user over time can make, for example, the real-time learning component 402 learn that the user's presentations frequently go later than their scheduled time, and thus, in such instances, the real-time learning component 402 may act to provide a buffer time (e.g., 30 minutes) after the scheduled end of a meeting past which the other applications can begin interrupting the slide presentation application again, so as to not interrupt future meetings likely to go late. This analysis may be even more complex, utilizing multiple pieces of information to learn and apply more complex patterns, such as that the user's presentations at work often go late but when the user is giving presentations at places other than work, such as at conferences or client sites, the user's presentations often end on time.

The location information may also be even more precise than just recognizing that the user is at work. It may be recognized that the user is in a certain conference room at work that has been designated for the meeting, thus allowing the system to assume the presentation has begun, whereas if it is recognized that the user is elsewhere at work the presentation has not begun.

As described earlier, the types of alerts blocked may be even more detailed than merely just all alerts coming from particular lower status applications. The substance of the alert may be examined and utilized in determining whether to allow or block the alert. For example, if the real-time learning component 402 learns, as described above, that the user is giving a presentation and is located in the conference room where the presentation is to take place, a calendar reminder for the meeting may be blocked, since it is not necessary for the user to be reminded of that fact, even if the presentation has not begun yet. Yet, if the presentation has not begun yet, other alerts, such as a text message from the user's wife to pick up dinner on the way home, may be allowed through.

As described briefly above, the system of the present disclosure may operate over multiple devices. In such a use case, for example, a user may have a smartphone in his pocket while giving a presentation with his laptop computer. The system is intelligent enough to recognize that the laptop computer is giving the presentation and block alerts sent to the user's smartphone during the presentation, even though there is nothing contained on smartphone itself indicating that the presentation is going on.

In another example use case, a school may establish a school schedule that can be integrated into student calendar applications. In such a use case, the system can assume that during scheduled class hours the user should not be disturbed except in emergency, and may act to block, for example, incoming phone calls and text messages unless from family members. This helps to ensure a distraction-free environment during classes.

In another example use case, audio information gathered from a microphone may be used with voice recognition software to recognize who is speaking around the device. There may be certain people (e.g., the CEO of the company, a professor) whom the user would not want to be interrupted while listening to or conversing with. The system is then able to recognize that these “VIPs” are speaking and ensure that the smartphones of employees/students do not ring or indicate text messages while they are speaking.

In another example use case, a user is participating in a video conference at work on his desktop computer. The user has other applications running in the background such as an email client, and instance messaging program, etc. Given that the user is using an application which requires multiple users to interact, the system may presume that the user most likely would not wish to be interrupted and may block the sounds accompanying some or all of the notifications coming from these other applications. In one example embodiment, however, while the sounds may be blocked, the visual alerts may continue to be provided.

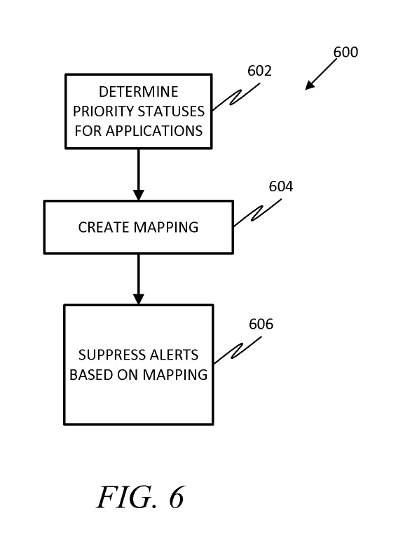

FIG. 6 is a flow diagram illustrating a method 600, in accordance with an example embodiment, of managing alerts from software applications. At operation 602, a priority status can be determined for one or more of a plurality of software applications. At operation 604, a mapping between the one or more of the plurality of software applications and each corresponding priority status can be created. At operation 606, based on the mapping, one or more alerts received from the plurality of software applications can be suppressed. Suppression may involve many different things, ranging from completely preventing the alert from triggering any action perceivable to the user to modifying how the alert or alerts are perceived (e.g, changing a ringtone, changing an audible ring to a vibration, etc.).

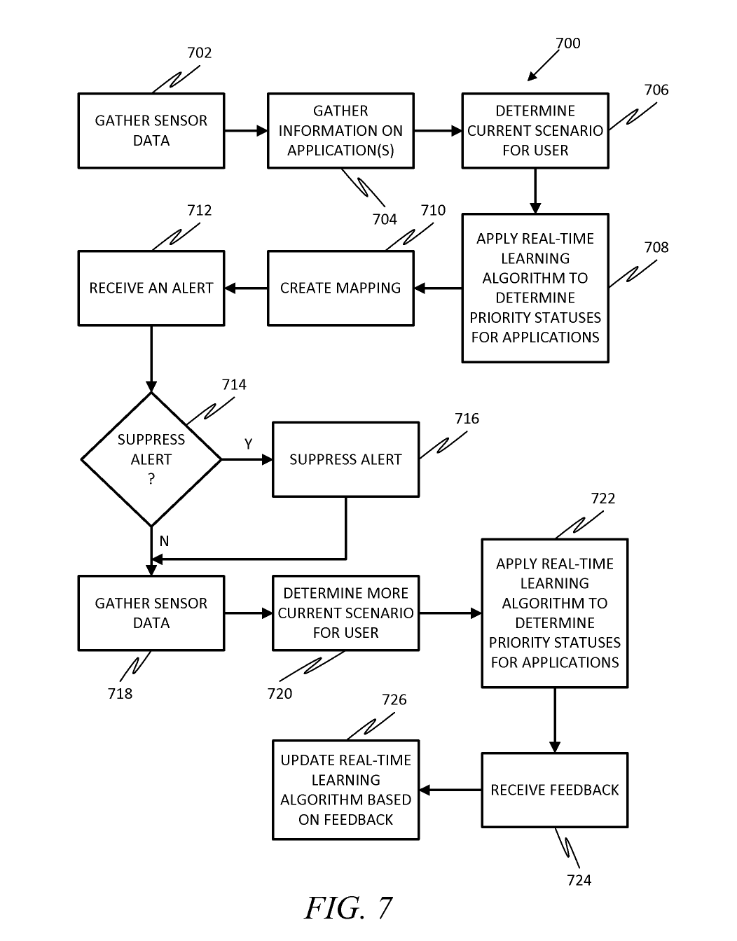

FIG. 7 is a flow diagram illustrating a method 700, in accordance with another example embodiment, of managing alerts from software applications. At operation 702, sensor data from one or more sensors on one or more devices can be gathered. At operation 704, information about one or more applications running on one or more devices can be gathered. At operation 706, a current scenario for a user can be determined based on the sensor data and the information about one or more applications. At operation 708, a real-time learning algorithm can be applied to the scenario to determine priority status for each of the one or more applications running on the one or more devices. At operation 710, a mapping can be created by the real-time learning algorithm, the mapping including the one or more applications running on the one or more devices and corresponding priority statuses. At operation 712, an alert from one of the one or more applications can be received. At operation 714, the mapping can be checked to determine if the mapping suggests that the alert be suppressed. If so, then at operation 716 the alert is suppressed.

At a later time, at operation 718, sensor data can be gathered again. This may include changes to the sensor data gathered in operation 704, such as an update to the current clock, or a change in location, but could include new types of sensor data, either in lieu of or in addition to changes in the previous sensor data.

At operation 720, a more current scenario for the user can be determined based on the sensor data from operation 718 and the information about one or more applications. At operation 722, the real-time algorithm can be applied to the more current scenario to determine updated priority status for each of one or more applications running on the one or more device.

At operation 724, feedback may be received from a user. This feedback may include, for example, an indication that a particular alert that was received should have been suppressed or that a particular alert that was not received should not have been suppressed. At operation 726, the real-time learning algorithm can be updated using the feedback.

### Example Mobile Device

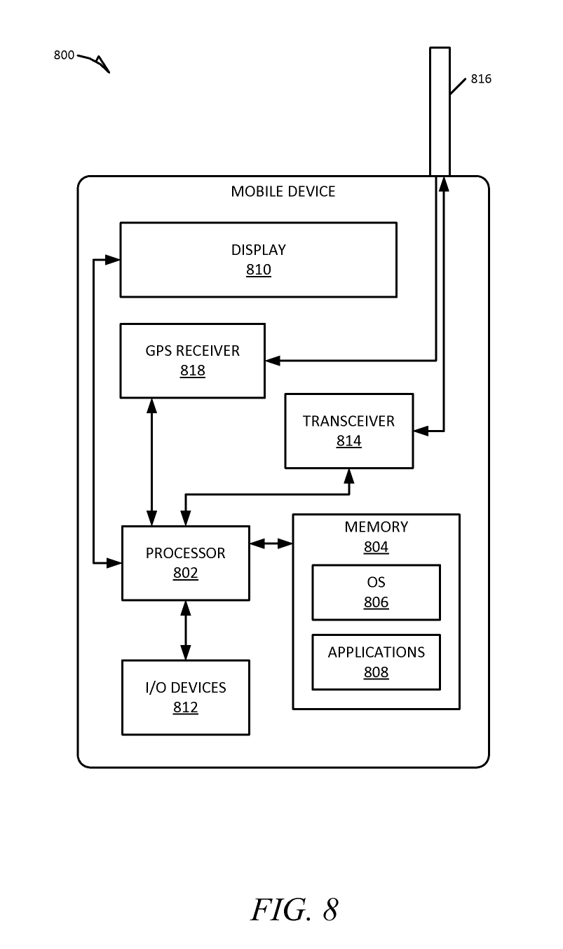

FIG. 8 is a block diagram illustrating a mobile device 800, according to an example embodiment. The mobile device 800 may include a processor 802. The processor 802 may be any of a variety of different types of commercially available processors suitable for mobile devices (for example, an XScale architecture microprocessor, a microprocessor without interlocked pipeline stages (MIPS) architecture processor, or another type of processor 802). A memory 804, such as a random access memory (RAM), a flash memory, or other type of memory, is typically accessible to the processor 802. The memory 804 may be adapted to store an operating system (OS) 806, as well as applications 808, such as a mobile location-enabled application that may provide location-based services (LBSs) to a user. The processor 802 may be coupled, either directly or via appropriate intermediary hardware, to a display 810 and to one or more input/output (I/O) devices 812, such as a keypad, a touch panel sensor, a microphone, and the like. Similarly, in some embodiments, the processor 802 may be coupled to a transceiver 814 that interfaces with an antenna 816. The transceiver 814 may be configured to both transmit and receive cellular network signals, wireless data signals, or other types of signals via the antenna 816, depending on the nature of the mobile device 800. Further, in some configurations, a GPS receiver 818 may also make use of the antenna 816 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 802 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field-programmable gate array (FPGA) or an application-specific integrated circuit (ASIC)) to perform certain operations. A hardware-implemented module may also comprise programmable logic or circuitry (e.g., as encompassed within a general-purpose processor 802 or other programmable processor 802) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 802 configured using software, the general-purpose processor 802 may be configured as respective different hardware-implemented modules at different times. Software may accordingly configure the processor 802, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine, but deployed across a number of machines. In some example embodiments, the processor 802 or processors 802 may be located in a single location (e.g., within a home environment, an office environment, or a server farm), while in other embodiments the processors 802 may be distributed across a number of locations.

The one or more processors 802 may also operate to support performance of the relevant operations in a “cloud computing” environment or as a “software as a service” (SaaS). For example, at least some of the operations may be performed by a group of computers (as examples of machines including processors 802), these operations being accessible via a network (e.g., the Internet) and via one or more appropriate interfaces (e.g., application program interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 802, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 802 executing a computer program to perform functions by operating on input data and generating output. Method operations can also be performed by, and apparatus of example embodiments may be implemented as, special-purpose logic circuitry, e.g., a field-programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 802), or in a combination of permanently and temporarily configured hardware may be a design choice. Below are set out hardware (e.g., machine) and software architectures that may be deployed, in various example embodiments.

### Example Machine Architecture and Machine-Readable Medium

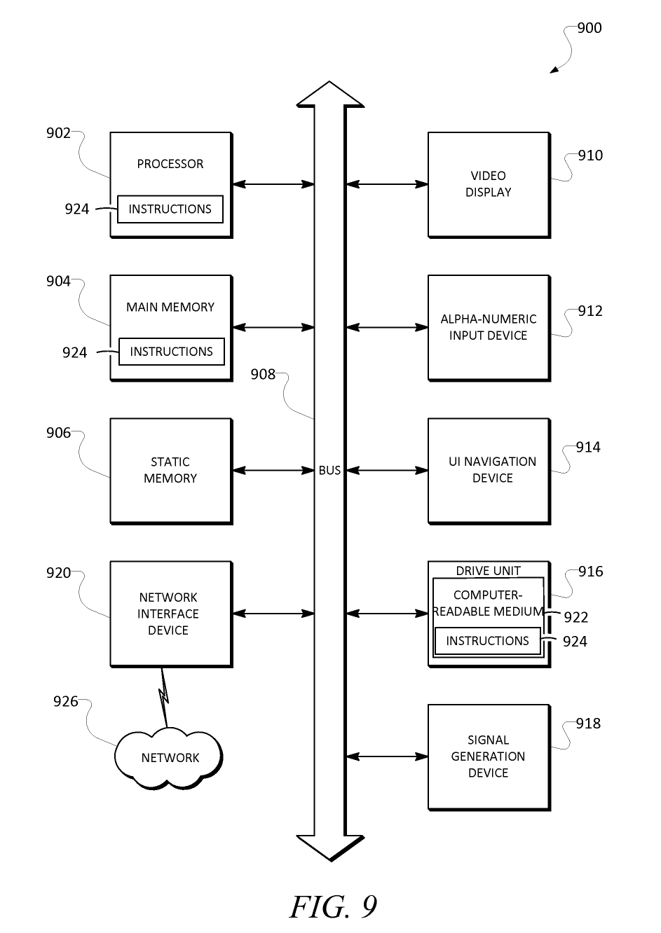

FIG. 9 is a block diagram of a machine in the example form of a computer system 900 within which instructions 924 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute a set (or multiple sets) of instructions 924 to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (e.g., cursor control) device 914 (e.g., a mouse), a drive unit 916, a signal generation device 918 (e.g., a speaker) and a network interface device 920.

### Machine-Readable Medium

The drive unit 916 includes a computer-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting computer-readable media 922.

While the computer-readable medium 922 is shown in an example embodiment to be a single medium, the term “computer-readable medium” may include a single medium or multiple media (e.g., a centralized or distributed database, and/or associated caches and servers) that store the one or more instructions 924 or data structures. The term “computer-readable medium” shall also be taken to include any tangible medium that is capable of storing, encoding or carrying instructions 924 for execution by the machine and that cause the machine to perform any one or more of the methodologies of the present disclosure, or that is capable of storing, encoding or carrying data structures utilized by or associated with such instructions 924. The term “computer-readable medium” shall accordingly be taken to include, but not be limited to, solid-state memories, and optical and magnetic media. Specific examples of computer-readable media 922 include non-volatile memory, including, by way of example, semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a network 926 using a transmission medium. The instructions 924 may be transmitted using the network interface device 920 and any one of a number of well-known transfer protocols (e.g., HTTP). Examples of communication networks 926 include a local area network (“LAN”), a wide area network (“WAN”), the Internet, mobile telephone networks, plain old telephone (POTS) networks, and wireless data networks (e.g., WiFi and WiMAX networks). The term “transmission medium” shall be taken to include any intangible medium that is capable of storing, encoding or carrying instructions 924 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single embodiment if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
one or more hardware processors;
a plurality of software applications;
an operating system comprising:
an application priority component comprising one or more processors and configured to determine a priority status for one or more of the plurality of software applications, the determining of a priority status comprising gathering sensor data from one or more sensors located on a user device, gathering information about one or more applications running on the user device, calculating a current application scenario based on the sensor data and the information about one or more applications, and utilizing a real-time learning component to generate a real-time mapping between the current application scenario and a priority status for a current application based on past usage information and user feedback; and
an alert management component configured to suppress one or more alerts received from the plurality of software applications based on the determined priority status for one or more of the plurality of software applications and based on a comparison between content contained in the one or more alerts and an alert content type contained in an alert profile generated for the user from historical activity with respect to content having a same type as the content contained in the one or more alerts.

2. The system of claim 1, wherein a plurality of the plurality of software applications are a part of a software suite and wherein one of the plurality of the plurality of software applications comprises:
a second application priority component configured to determine a priority status for one or more of the plurality of software applications in the software suite; and
a second alert management component configured to suppress one or more alerts received from the plurality of software applications in the software suite based on the determined priority status for one or more of the plurality of software application in the software suite.

3. The system of claim 1, wherein the application priority component contains a real-time learning component which includes a machine learning algorithm configured to learn user and environmental patterns.

4. The system of claim 3, wherein the application priority component further contains a sensor gathering component configured to gather information from one or more sensors located on a device on which the application priority component resides.

5. The system of claim 4, wherein the application priority component further contains an application information gathering component configured to gather information on one or more of the plurality of applications.

6. The system of claim 5, wherein the real-time learning component is further configured to use the information from the one or more sensors and the information on the one or more of the plurality of applications to produce a dynamically alterable real-time mapping between the one or more plurality of applications and priority statuses for each of the one or more plurality of applications.

7. The system of claim 1, wherein at least one of the one or more of the plurality of applications is located on a different device than the operating system.

8. A method comprising:
determining a priority status for one or more of a plurality of software applications, the determining of a priority status comprising gathering sensor data from one or more sensors located on a user device, gathering information about one or more applications running on the user device, calculating a current application scenario based on the sensor data and the information about one or more applications, and utilizing a real-time learning component to generate a real-time mapping between the current application scenario and a priority status for a current application based on past usage information and user feedback;
creating a mapping between the one or more of a plurality of software applications and each corresponding priority status; and
based on the mapping and based on a comparison between content contained in the one or more alerts and an alert content type contained in an alert profile generated for the user from historical activity with respect to content having a same type as the content contained in the one or more alerts, suppressing one or more alerts received from the plurality of software applications.

9. The method of claim 8, wherein the priority status is determined dynamically in real-time by examining sensor data from one or more sensors and information from one or more of the plurality of software applications.

10. The method of claim 9, wherein the sensor data includes location.

11. The method of claim 9, wherein the sensor data includes current time information.

12. The method of claim 9, wherein the sensor data includes audio information.

13. The method of claim 9, wherein the priority status is further determined dynamically using a real-time learning algorithm that identifies, from the sensor data, a current scenario for the user and uses past usage information from the user to deduce a likelihood that the user does not wish to be interrupted while using a particular application.

14. The method of claim 9, further comprising maintaining an alert profile, the alert profile containing a mapping between alert types and relative importance levels.

15. The method of claim 9, further comprising maintaining an alert profile, the alert profile containing a mapping between alert content types and relative importance levels.

16. The method of claim 14, wherein the suppressing one or more alerts is further based on the alert profile.

17. A non-transitory machine-readable storage medium comprising instructions, which when implemented by one or more machines, cause the one or more machines to perform operations comprising:
determining a priority status for one or more of the plurality of software applications, the determining of a priority status comprising gathering sensor data from one or more sensors located on a user device, gathering information about one or more applications running on the user device, calculating a current application scenario based on the sensor data and the information about one or more applications, and utilizing a real-time learning component to generate a real-time mapping between the current application scenario and a priority status for a current application based on past usage information and user feedback;
creating a mapping between the one or more of a plurality of software applications and each corresponding priority status; and
based on the mapping and based on a comparison between content contained in the one or more alerts and an alert content type contained in an alert profile generated for the user from historical activity with respect to content having a same type as the content contained in the one or more alerts, suppressing one or more alerts received from the plurality of software applications.

18. The non-transitory machine-readable storage medium of claim 17, wherein the priority status is further determined dynamically using a real-time learning algorithm that identifies, from the sensor data, a current scenario for a user and uses past usage information from the user to deduce a likelihood that the user does not wish to be interrupted while using a particular application.

19. The non-transitory machine-readable storage medium of claim 17, wherein the operations further comprise maintaining an alert profile, the alert profile containing a mapping between alert types and relative importance levels.

20. The non-transitory machine-readable storage medium of claim 17, wherein the operations further comprise maintaining an alert profile, the alert profile containing a mapping between alert content types and relative importance levels.
